(19) United States
(12) Patent Application Publication
(10) Pub. No.: US 2025/0028996 A1
(43) Pub. Date: Jan. 23, 2025

(54) AN ADAPTIVE PERSONALIZED FEDERATED LEARNING METHOD SUPPORTING HETEROGENEOUS MODEL

(71) Applicants: ZHEJIANG UNIVERSITY, HANGZHOU, Zhejiang Province (CN); ZHEJIANG UNIVERSITY ZHONGYUAN INSTITUTE, ZHENGZHOU, Henan Province (CN)

(72) Inventors: SHUIGUANG DENG, HANGZHOU, ZHEJIANG PROVINCE (CN); ZHEN QIN, HANGZHOU, ZHEJIANG PROVINCE (CN)

(21) Appl. No.: 18/281,938

(22) PCT Filed: Mar. 17, 2023
(86) PCT No.: PCT/CN2023/082145

§ 371 Date: Sep. 13, 2023

(30) Foreign Application Priority Data
Aug. 1, 2022 (CN) 202210916817.8

(51) Int. Cl. G06N 20/00

(52) U.S. Cl. CPC G06N 20/00

(57) ABSTRACT

The present invention discloses an adaptive personalized federated learning method supporting heterogeneous model, based on the use of models with different structures by various participants supporting federated learning, learning the dynamic weight used for model ensemble and introducing optimization objectives for model integration in the process of training model parameters, realizing highly accurate personalized federated learning with heterogeneous and self adaptive data, the participants are enabled to benefit from federated learning in scenes with heterogeneous data at different levels. The adaptive personalized federated learning method of the present invention does not need to introduce new hyper parameters, and can be conveniently deployed in the existing federated learning system; comparing with the traditional personalized federated learning method, the present invention has stronger adaptability.

### TECHNICAL FIELD

The present invention belongs to the field of artificial intelligence technology, in particular to an adaptive personalized federated learning method supporting heterogeneous model.

### DESCRIPTION OF RELATED ART

Artificial intelligence has become one of the important technologies driving social and economic development, which has been deeply integrated into every corner of people's lives. With the continuous breakthroughs in core technologies of artificial intelligence represented by deep learning, artificial intelligence technology gradually relies on a large amount of data for model training, however, this has brought about the problem of excessive collection and use of personal privacy data, leading to a growing awareness and concern about data privacy. The introduction of data regulatory policies and the emergence of relevant regulatory technologies have promoted the development of artificial intelligence technology for privacy protection, and promoted the progress of federated learning, a computing model that cooperates with multiple participants to train machine learning models on the premise of protecting data privacy.

However, the existing federated learning methods face two problems: data heterogeneity and model heterogeneity; On one hand, the not-independent and identically distributed (non-IID) characteristics of training data distributed on each participating device will seriously restrict the effectiveness of federated learning. There are many studies show that the traditional federated averaging method converges slowly when the distribution of data held by each participant is different, or even diverges. Although many researchers have proposed a variety of personalized federated learning methods for the problem of data heterogeneity faced by federated learning, such as model regularization, local fine-tuning, model interpolation, and multi-task learning, these methods are only applicable to some scenarios with data heterogeneity. In real world, the training data is usually widely distributed on various participating devices, and the degree of data heterogeneity is usually unknown, causing difficulty to select a suitable personalized federated learning method, which gives rise to the demand for adaptive personalized federated learning technology. On the other hand, the existing personalized federated learning methods are more oriented toward the scene of homogeneous model, that is, each participant needs to use a model with the same structure. When each participant in federated learning comes from different business organizations, each participant may prefer to use a model that is more suitable for their business data, and the model structure may be the secret of each business organization. Therefore, a federated learning method that enables differentiated model structure can further protect the privacy of participants and provide a higher degree of personalization.

Deep Mutual Learning provides the technical basis for training two different models based on the same data, on this basis, some researchers have proposed the Federated Mutual Learning method, where participants of federated learning train both private models and global shared models at the same time, the private model is kept locally, and its model structure and parameters are not shared, the structure and parameters of the global shared model are consistent across all participants, and the central server is responsible for periodic aggregation and distribution, serving as a medium for knowledge sharing among all participants.

In federated learning systems, each participant holds two different models, comprising the private model and the global shared model. In order to improve the accuracy of the model, a simple approach is to directly average the output predictions of the two models, and take the average prediction result as the final result. However, the performance of the two models on different data has certain differences: in the case of highly heterogeneous data, the private model learns the distribution of the corresponding participant's private dataset well, thus, it has good accuracy on the private dataset of the corresponding participants, while the global shared model is often affected by data heterogeneity and has poor accuracy. In situations where data distributions tend to be homogeneous, the global shared model benefits from knowledge sharing among multiple participants and have good accuracy, while the private model mainly relies on the knowledge of corresponding participants, resulting in poor accuracy, directly integrating two models will negatively affect the accuracy of integration by models with low accuracy.

### SUMMARY OF THE INVENTION

In view of the above, the present invention provides an adaptive personalized federated learning method that supports heterogeneous model, so as to carry out adaptive personalized federated learning when the private model structure and parameters of participants are unknown, and enable participants to benefit from federated learning in scenes with different levels of data heterogeneity.

An adaptive personalized federated learning method supporting heterogeneous model, comprising the following steps:
(1) initializing parameters of a global shared model by a central server;
(2) the central server sending the parameters of the global shared model to each participant of the federated learning, after receiving the parameters of the global shared model, the participants updating their own global shared model with the parameters;
(3) the participants performing learning for adaptability to update the weights of private models;
(4) the participants using newly obtained private training data to train both the private models and the globally shared model by using a stochastic gradient descent algorithm;
(5) the participants uploading the parameters of the globally shared model to the central server after one round of iterative training;
(6) after collecting enough parameters of the global shared model, the central server aggregating these model parameters to obtain new parameters of the global shared model, and then returning to step (2) to distribute the new parameters of the global shared model to each participant, and then circulating until the loss function of all models converges or reaches the maximum number of iterations in federated learning.

Furthermore, the global shared model is trained by the participants of federated learning, and the central server is responsible for aggregation, each participant holds a copy of the global shared model. On the one hand, the global shared model is used for inference by each participant after the completion of federated learning training, and on the other hand, it serves as a medium for knowledge sharing among participants.

Furthermore, the private models are the models held by each participant of federated learning, and the structure and parameters are not disclosed, the structure of the private models held by each participant are different.

Furthermore, the participants are end devices in the federated learning system, in order to profit from the federated learning system, that is, to obtain a model with more accuracy, the participants uploads model parameters to the central server and downloads aggregated model parameters from the central server.

Furthermore, the specific implementation of step (3) is as follows: the participants first divide a small portion (such as 5% of the training data) from the obtained private training data as a validation set, and infer the private models and the global shared model on the validation set, obtaining the prediction output result pₚᵣᵢ of the private models and the prediction output result pₛₕₐ of the global shared models, then the participants update the weight of the private models through the stochastic gradient descent method, and the update expression is as follows:

$${λ}_{i}^{′} = {λ}_{i} - η {∇}_{{λ}_{i}} {L}_{C E} ( {p}_{aen} , y )$$

wherein, λᵢ is the weight of the private model before update, λ′ᵢ is the weight of the private model after update, η represents learning rate, ∇_{λ}_{ᵢ} represents L_{CE} (pₐₑₙ, y) to λᵢ gradient, L_{CE} (pₐₑₙ, y) represents cross entropy of pₐₑₙ and y, pₐₑₙ represents the weighted average result of pₚᵣᵢ and pₛₕₐ, y is the ground-truth label.

Furthermore, the loss function expression used for private model training in step (4) is as follows:

$${L}_{p r i} = {L}_{C E} ( {P}_{pri} , y ) + {D}_{K L} ( {p}_{p r i} ‖ {p}_{s h a} ) + {L}_{C E} ( {p}_{aen} , y )$$

wherein, Lₚᵣᵢ is the loss function of the private model, L_{CE} (pₚᵣᵢ, y) represents cross entropy of pₚᵣᵢ and y, L_{CE} (pₐₑₙ, y) represents cross entropy of pₐₑₙ and y, D_{KL} (pₚᵣᵢ∥pₛₕₐ) represents the KL divergence of pₚᵣᵢ relative to pₛₕₐ, pₐₑₙ represents the weighted average result of pₚᵣᵢ and pₛₕₐ, y is the ground-truth label, pₛₕₐ is the prediction output result of the global shared model.

Furthermore, the expression of the loss function used for the global shared model training in step (4) is as follows:

$${L}_{s h a} = {L}_{C E} ( {p}_{s h a} , y ) + {D}_{K L} ( {p}_{s h a} \vert \vert {p}_{p r i} ) + {L}_{C E} ( {p}_{aen} , y )$$

wherein, Lₛₕₐ is the loss function of the global shared model, L_{CE} (pₛₕₐ, y) represents cross entropy of pₛₕₐ and y, L_{CE} (pₐₑₙ, y) represents cross entropy of pₐₑₙ and y, D_{KL} (pₛₕₐ∥pₚᵣᵢ) represents the KL divergence of pₛₕₐ relative to pₚᵣᵢ, pₐₑₙ represents the weighted average result of pₚᵣᵢ and pₛₕₐ, y is the ground-truth label, pₚᵣᵢ is the prediction output result of the private model, pₛₕₐ is the prediction output result of the global shared model.

Furthermore, in step (6), after collecting sufficient parameters of the global shared model, the central server executes a federated averaging algorithm to aggregate these model parameters, and then distributes the aggregated new parameters of the global shared model to all participants.

The present invention realizes federated learning with high accuracy through adaptability to data heterogeneity while supporting participants utilize models with heterogeneous architectures. This is fulfilled by learning dynamic weights for model ensemble and introducing the ensemble predictions into training objectives during local training. Thus, participants can benefit from federated learning in the scenarios with different levels of data heterogeneity. In addition, the adaptive personalized federated learning method of the present invention does not need to introduce new hyper parameters, and can be conveniently deployed in the existing federated learning system. Specifically, the present invention has the following beneficial technical effects:
1. The present invention provides a federated learning approach supporting heterogeneous model, on the basis of protecting the privacy of private training data of the participants, the present invention further protects the privacy of participants' model structures and thus realizes broader privacy protection.
2. The present invention federated learning supporting heterogeneous models, which enables participants of federated learning to benefit from federated learning in scenes with different levels of data heterogeneity (where the benefit means that a model with higher accuracy can be obtained compared with the situation where each client trains its local model individually).
3. The present invention solves the problem that the existing personalized federated learning method is only effective in the context of specific degree of data heterogeneity. Comparing with the traditional personalized federated learning method, the present invention has stronger adaptability to data heterogeneity.

### BRIEF DESCRIPTION OF THE DRAWINGS

FIG. 1 is the architecture diagram of the adaptive personalized federated learning system of the present invention.

FIG. 2 is the flow diagram of the adaptive personalized federated learning method of the present invention.

### DETAILED DESCRIPTION OF THE INVENTION

In order to provide a more specific description of the present invention, the following will provide a detailed explanation of the technical solution of the present invention in conjunction with the accompanying drawings and specific implementation methods.

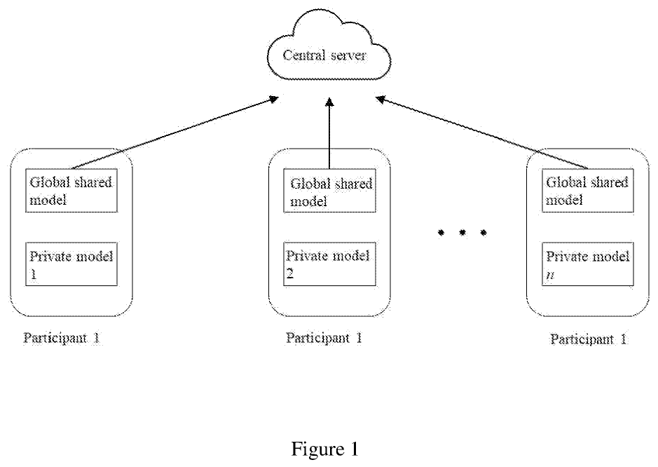

The system architecture of the adaptive personalized federated learning method of the present invention supporting heterogeneous model is shown in FIG. 1, the system mainly consists of a central server and participants, the central server is responsible for coordinating each participant to run the federated learning method, comprising initialization of the global shared model, reception, aggregation and distribution of the global shared model, at the same time, it is responsible for checking whether the global shared model has converged or whether the adaptive personalized federated learning method has reached enough rounds to decide whether to terminate the method.

In this embodiment, each participant cooperatively trains an image classification model by using the method of the present invention, and uses the private model and global shared model obtained from the training for subsequent inference.

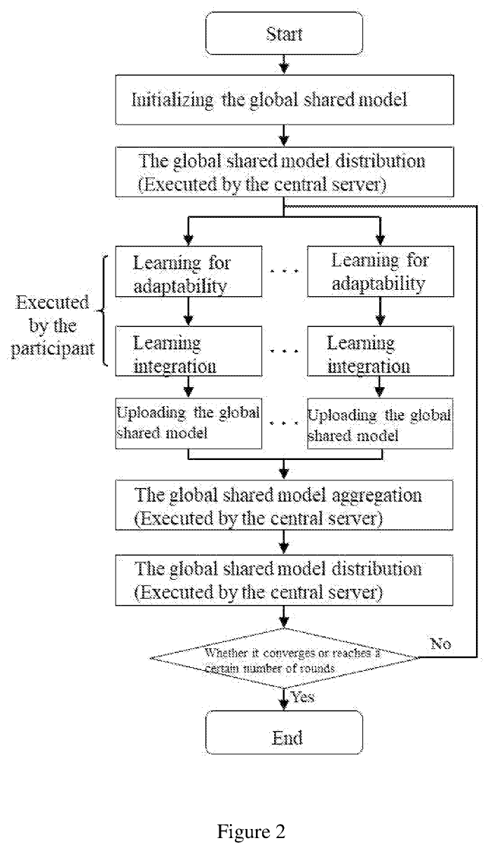

Firstly, participants coordinate and select a model for image classification as the global shared model, and jointly agree on parameters such as the number of rounds for the overall iteration of the method, then, with the coordination of the central server, the following process steps are run as shown in FIG. 2:
(1) initializing the global shared model: the central server initializes the parameters of the selected global shared model, the initialization algorithm can be coordinated in advance by various participants, such as through Xavier initialization method or Kaiming initialization method, this embodiment does not impose constraints.
(2) the global shared model distribution: after completing the parameters initialization of the global shared model, the central server sends the parameters of the global shared model to each participant of the federated learning, after receiving the parameters of the global shared model, the participants update their own global shared model with the parameters.
(3) learning for adaptability: in this embodiment, each participant of federated learning holds a private training set composed of several private training data, in which each training data sample is a picture labeled with labels. Each participant of federated learning randomly samples 5% of the training data from the private training set held by itself as the verification set. Each data sample in the verification set is used as input and sent to the private model and the global shared model for inference to obtain the classification result pₚᵣᵢ output by the private model and the classification result pₛₕₐ output by the global shared model, and obtaining the weighted average classification result pₐₑₙ according to the following equation:

$${p}_{a e n} = {λ}_{i} \cdot {p}_{pri} + ( 1 - {λ}_{i} ) \cdot {p}_{s h a}$$

subsequently, the participant's private model weight coefficient λᵢ is updated by using the stochastic gradient descent algorithm, as shown in the following equation:

$${λ}_{i}^{′} = {λ}_{i} - η {∇}_{{λ}_{i}} {L}_{C E} ( {p}_{aen} , y )$$

wherein, y represents the label of the image.

In this embodiment, in order to enhance the stability of λᵢ learning process, λᵢ is updated by using a small batch gradient descent method, that is, packaging several images into a batch of data and inputting them into two models at once to obtain the classification results of a batch of data, and updating the weight Ai according to the above formula based on the classification results of a batch of data. After several rounds of iteration, λᵢ will converge to a suitable value, the learning of self adaptability step ends. In this embodiment, λᵢ iteratively updates several rounds (epochs) on the validation set, it should be noted that the modification scheme based on the number of iteration updates for λᵢ is still within the scope of protection of the present invention.
(4) learning integration: each participant runs this step independently; for one participant, it uses its own private training data to train both the private model and the global shared model based on the stochastic gradient descent algorithm, the goal of the private model training process is to minimize the loss function Lₚᵣᵢ defined below:

$${L}_{p r i} = {L}_{C E} ( {P}_{pri} , y ) + {D}_{K L} ( {p}_{p r i} ‖ {p}_{s h a} ) + {L}_{C E} ( {p}_{aen} , y )$$

wherein, L_{CE} (p, y) represents the cross entropy loss function calculated based the image classification result p and the image's real label y output by the model, D_{KL}(pₚᵣᵢ∥pₛₕₐ) represents the KL divergence calculated by the classification result pₚᵣᵢ output by the private model relative to the classification result pₛₕₐ output by the global shared model;
the objective of training the global shared model is to minimize the following loss function Lₛₕₐ:

$${L}_{s h a} = {L}_{C E} ( {p}_{s h a} , y ) + {D}_{K L} ( {p}_{s h a} \vert \vert {p}_{p r i} ) + {L}_{C E} ( {p}_{aen} , y )$$

In order to complete the above training task, this embodiment adopts a small batch gradient descent method for training, specifically, assuming that the k-th batch of data is used during the t-th training, based on the private model and global shared model trained for the t−1st time, the classification results pₚᵣᵢ and pₛₕₐ are obtained by using the k-th batch of data as input, and then updating the private model based on the definition of Lₚᵣᵢ, and then updating the global shared model with the definition of Lₛₕₐ; after repeating the above steps for several rounds, the learning integration step ends.
(5) uploading the global shared model: after completing the training in steps (3) and (4), the participants of federated learning upload their trained global shared model to the central server, while keeping the private model locally.
(6) aggregation and distribution of the global shared model: after receiving sufficient global shared models, the central server performs federated averaging to aggregate these global shared models. Considering that the participants of federated learning are usually not in the same local area network, and the performance of each participant's equipment is different, the central server will set a certain waiting time, and the global shared model received within the waiting time window will be used for aggregation, after the time window ends, it will no longer receive the current round of global shared model. After completing the time window of the current round, the central server aggregates a new global shared model by using the federated average algorithm, the aggregation process is as follows:

$${w}_{s h a} = \frac{1}{n} {\sum }_{i = 1}^{n} {w}_{s h a}^{i}$$

wherein, wₛₕₐ represents the new global shared model after aggregation, wₛₕₐⁱ represents the global shared model uploaded by the i-th participant.

Subsequently, the central server issues the new global shared model after aggregation to each participant; when step (6) is completed, the central server will check whether the cycle number has reached the preset number of overall iteration rounds, or whether the accuracy of the model has not been further improved after several consecutive rounds of aggregation; if one of the above two criteria is met, the method terminates, otherwise it will be re executed from step (3).

The above description of the embodiments is for the convenience of ordinary technical personnel in the art to understand and apply the present invention. Those familiar with the art can clearly make various modifications to the above embodiments and apply the general principles explained here to other embodiments without the need for creative labor. Therefore, the present invention is not limited to the aforementioned embodiments. According to the disclosure of the present invention, the improvements and modifications made by those skilled in the art should be within the scope of protection of the present invention.

1. An adaptive personalized federated learning method supporting heterogeneous model, comprising the following steps:
(1) initializing parameters of a global shared model by a central server;
(2) the central server sending the parameters of the global shared model to each participant of the federated learning, after receiving the parameters of the global shared model, the participants updating their own global shared model with the parameters;
(3) the participants performing learning for adaptability to update the weights of private models;
(4) the participants using newly obtained private training data to train both the private models and the globally shared model by using a stochastic gradient descent algorithm;
(5) the participants uploading the parameters of the globally shared model to the central server after one round of iterative training;
(6) after collecting enough parameters of the global shared model, the central server aggregating these model parameters to obtain new parameters of the global shared model, and then returning to step (2) to distribute the new parameters of the global shared model to each participant, and then circulating until the loss function of all models converges or reaches the maximum number of iterations in federated learning;
wherein, the private models are the models held by each participant of federated learning, and the structure and parameters are not disclosed, the structure of the private models held by each participant are different;
wherein, the specific implementation of step (3) is as follows: the participants first dividing a small portion (such as 5% of the training data) from the obtained private training data as a validation set, and inferring the private models and the global shared model on the validation set, obtaining the prediction output result pₚᵣᵢ of the private models and the prediction output result pₛₕₐ of the global shared models, then the participants updating the weight of the private models through the stochastic gradient descent method, and the update expression is as follows:
$${λ}_{i}^{′} = {λ}_{i} - η {∇}_{{λ}_{i}} {L}_{C E} ( {p}_{aen} , y )$$
wherein, λᵢ is the weight of the private model before update, λ′ᵢ is the weight of the private model after update, n represents learning rate, ∇_{λ}_{ᵢ} represents L_{CE} (pₐₑₙ y) to λᵢ gradient, L_{CE} (pₐₑₙ, Y) represents cross entropy of pₐₑₙ and y, pₐₑₙ represents the weighted average result of pₚᵣᵢ and pₛₕₐ, y is the ground-truth label;
wherein, the loss function expression used for private model training in step (4) is as follows:
$${L}_{p r i} = {L}_{C E} ( {P}_{pri} , y ) + {D}_{K L} ( {p}_{p r i} ‖ {p}_{s h a} ) + {L}_{C E} ( {p}_{aen} , y )$$
wherein, Lₚᵣᵢ is the loss function of the private model, L_{CE}(pₚᵣᵢ, y) represents cross entropy of pₚᵣᵢ and y, L_{CE} (pₐₑₙ, y) represents cross entropy of pₐₑₙ and y, D_{KL} (pₚᵣᵢ∥pₛₕₐ) represents the KL divergence of pₚᵣᵢ relative to pₛₕₐ, pₐₑₙ represents the weighted average result of pₚᵣᵢ and pₛₕₐ, y is the ground-truth label, pₛₕₐ is the prediction output result of the global shared model;
wherein, the expression of the loss function used for the global shared model training in step (4) is as follows:
$${L}_{s h a} = {L}_{C E} ( {p}_{s h a} , y ) + {D}_{K L} ( {p}_{s h a} \vert \vert {p}_{p r i} ) + {L}_{C E} ( {p}_{aen} , y )$$
wherein, Lₛₕₐ is the loss function of the global shared model, L_{CE}(pₛₕₐ,y) represents cross entropy of pₛₕₐ and y, L_{CE}(pₐₑₙ, y) represents cross entropy of pₐₑₙ and y, D_{KL} (pₛₕₐ∥pₚᵣᵢ) represents the KL divergence of pₛₕₐ relative to pₚᵣᵢ, pₐₑₙ represents the weighted average result of pₚᵣᵢ and pₛₕₐ, y is the ground-truth label, pₚᵣᵢ is the prediction output result of the private model, pₛₕₐ is the prediction output result of the global shared model.

2. The adaptive personalized federated learning method according to claim 1, wherein, the global shared model is trained by the participants of federated learning, and the central server is responsible for aggregation, each participant holds a copy of the global shared model; on the one hand, the global shared model is used for inference by each participant after the completion of federated learning training, and on the other hand, the global shared model serves as a medium for knowledge sharing among participants.

3. (canceled)

4. The adaptive personalized federated learning method according to claim 1, wherein, the participants are end devices in the federated learning system, in order to profit from the federated learning system, that is, to obtain a model with more accuracy, the participants upload model parameters to the central server and downloads aggregated model parameters from the central server.

5-7. (canceled)

8. The adaptive personalized federated learning method according to claim 1, wherein, in step (6), after collecting sufficient global shared models from the clients, the central server executes a federated averaging algorithm to aggregate the received models, and then distributes the aggregated new global shared model to all participants.
